(19) United States
(12) Patent Application Publication
(10) Pub. No.: US 2009/0293707 A1
(43) Pub. Date: Dec. 3, 2009

(54) Wood aging method for musical instruments

(76) Inventor: John Martin Suhr, Corona, CA (US)

Correspondence Address: Mr. Loyal M. Hanson;Hanson Law Corporation, P.O. Box 430, Fallbrook, CA, 92088-0430, US

(21) Appl. No.: 12/156,480

(22) Filed: Jun. 2, 2008

(51) Int. Cl. G10H 3/12

(52) U.S. Cl. 84/723

(57) ABSTRACT

A method for aging the wood of a musical instrument includes the steps of (i) providing a flat-surface-supportable audio-frequency transducer device of the type commercially available from Induction Dynamics, LLC of Overland Park, Kans. under the trademark SOLIDDRIVE that has a response of up to at least 15 KHz and a power handling capability of up to at least 100 watts, and (ii) providing an audio signal source for driving the transducer device. The method proceeds by placing the transducer device against the wood of the musical instrument and driving it with the audio signal source in order to thereby subject the wood to significant audio vibrations for accelerated wood-aging purposes. The transducer device may be set directly on a selected portion of the wood or be secured there with double-sided tape. An accelerometer device is placed sequentially against various selected portions of the wood to map the frequency response of those selected portions.

### BACKGROUND OF THE INVENTION

1. Technical Field

This invention relates generally to the field of musical instruments, and more particularly to a method for aging the wood used in guitars, violins, and other such wooden musical instruments, along with a method for analyzing the frequency response of the wood.

2. Description of Related Art

Many musicians share the understanding that a violin, guitar, or other wooden instrument sounds better with age. “Aged wood has improved tonal qualities,” they say. In keeping with that view, owners and craftsman have devised various techniques for aging the wood of musical instruments. Some have even used the automatic violin breaking-in apparatus in U.S. Pat. No. 2,911,872 issued Nov. 10, 1959, an apparatus that simultaneously plays two violins with motor-driven bows for tonal-improvement purposes. More recent techniques, however, achieve accelerated aging by subjecting the wood to vibrations for long periods of time using an audio source apart from the instrument.

U.S. Pat. No. 5,031,501 issued Jul. 16, 1991, for example, describes attaching an audio transducer to a guitar or other stringed musical instrument sounding board and then driving the transducer with an electrical sound signal in order to produce sound for the purpose of either artificially aging the instrument or providing accompaniment for a musician playing the instrument. The transducer is a known type having limited frequency range, limited power, and a mechanical output protrusion for use in coupling the transducer output to another object. A threaded screw measuring about 1.25 inches long is attached to the output protrusion, and the transducer is manually positioned near the bridge of the guitar so that the screw extends between the guitar strings to the wooden guitar body. The transducer is retained in place, and the end of the screw is forced to bear downwardly against the guitar body, by a lateral arm on the screw that bears upwardly against the guitar strings. When the transducer is excited with the electrical sound signal, vibrations pass from the transducer, to the screw, and from the screw to the guitar body. Although this technique achieves some artificial aging using an audio source apart from the instrument, it is frequency limited and power limited and involves attachment hardware that is complicated, prone to threatening string integrity, and limiting as to just where on the guitar the vibrations-transferring screw can be located (i.e., near the bridge of a filly assembled guitar).

U.S. Pat. No. 5,537,908 issued Jul. 23, 1996 describes securing a partially assembled or filly assembled wooden musical instrument to a shaker table or other vibrating fixture and then vibrating the fixture. This technique vibrates the whole instrument and it involves the time, expense, space requirements, and potential for damage to the instrument of securing the instrument to a large electromagnetic vibration fixture. Moreover, a typical range of shaker table frequencies extends only from about 20 to 2,000 Hertz (Hz) so that a filler range of audio frequencies is unavailable.

U.S. Patent Publication No. US 2007/0175320 A1 published Aug. 2, 2007 describes placing a wooden musical instrument in an enclosure where it is subjected to broadband audio sound waves produced by a 10-db speaker system that is located within the enclosure. Although this technique subjects the instrument to a greater range of frequencies, it involves the expense and space requirements of an enclosure with a suitable sound system. In addition, it vibrates the entire instrument by surrounding it with sound waves and leaves the user no way to apply audio vibrations at only a selected location on the instrument when desired (e.g., at the guitar body, neck, and/or headstock).

The foregoing examples show that the particulars of artificial/accelerated wood-aging techniques continue to be of recognized importance and interest to wooden instrument owners and craftsman. Existing techniques have certain drawbacks that need to be overcome, however, and so better techniques for accelerated aging of wooden instruments are needed.

### SUMMARY OF THE INVENTION

In view of the foregoing, it is an object of the present invention to provide an improved method of aging the wood of violins, guitars, and other wooden instruments that overcomes some of the drawbacks of the prior art. The present invention achieves this objective by providing a flat-surface-supportable audio-frequency transducer device having dual symmetrically opposed motors and a broad audio frequency response characteristic, and using that transducer device to vibrate the wood. A flat vibrating surface on the transducer device is placed on a selected portion of the wood without the need for complicated mounting hardware and without prior art restrictions as to its location on the wood. The device is then driven with an audio amplifier to provide powerful vibrations over a greater range or selected portion of the audio frequency range for accelerated wooden-aging purposes.

As used herein, the expression “flat-surface-supportable audio-frequency transducer device of the type having dual symmetrically opposed motors and a broad audio frequency response characteristic” refers to a transducer device of the type available from Induction Dynamics, LLC of Overland Park, Kans. under the trademark SOLIDDRIVE (e.g., Model SD1Desktop). Such a device is described in product literature of said Induction Dynamics, LLC as using high-powered neodymium magnets and dual symmetrically opposed motors that produce vibrations resulting in sound from nearly any rigid or semi-rigid surface on which the device is placed. Complicated mounting hardware is unnecessary for wood-aging purposes. The device includes a somewhat small body (e.g., a two-inch to three-inch diameter cylindrical body) with a flat vibrating “driving” surface at one end that a user places against the rigid or semi-rigid “driven” surface (i.e., the wood to be aged). The driving surface does not have a protrusion extending from it. The driving surface is placed directly at a desired location on the wood, or it is held on the wood by removable double-sided tape or other suitable means. Vibrations are transferred from the driving surface to the wood.

To paraphrase some of the more precise language appearing in the claims and further introduce the nomenclature used herein, a method for aging the wood of a musical instrument according to the invention includes the steps of (i) providing a flat-surface-supportable audio-frequency transducer device of the type having dual symmetrically opposed motors and a broad audio frequency response characteristic, and (ii) providing means for driving said transducer device, including an audio signal source. The method proceeds by placing said transducer device against the wood of the musical instrument and driving said transducer device with the audio signal source in order to thereby subject the wood to audio vibrations for accelerated wood-aging purposes.

In one form of the invention, the step of placing the transducer device against the wood of the musical instrument includes providing removable double-sided adhesive tape and using the removable double-side adhesive tape to hold the transducer device on the wood of the musical instrument. In another form of the invention, the step of placing the transducer device against the wood of the musical instrument includes setting the transducer device directly on the wood of the musical instrument. Preferably, the step of placing the transducer device against the wood of the musical instrument includes placing it against the body, neck, or headstock of the assembled instrument (e.g., a guitar). Alternatively, the wood is aged before the instrument is assembled. In addition, the transducer device preferably has a frequency response of up to at least about 15,000 KHz and a power level capability in a range of about 5 watts to about 100 watts, and the step of driving the transducer device includes driving it with an audio signal having a frequency range of up to at least about 15,000 KHz and a power level in the 5-watt to 100-watt range.

The method may include providing means for sensing the frequency response of a second selected portion of the wood, including an accelerometer or other suitable vibration-sensing device. The vibration-sensing device is placed against the second selected portion of the wood and the frequency response of that portion is sensed with the sensing device as the transducer device is driven by the audio signal source. A user can, for example, age the wood of the musical instrument and map its frequency response until the wood has a frequency response similar to the frequency response of some other musical instrument of interest.

Thus, the invention provides a better technique for accelerated aging of wooden instruments. The user is not power limited or limited by complicated string-threatening hardware as to just where on the guitar a vibrations-transferring screw can be located. There are not the time, expense, space requirements, and potential for damage of securing the instrument to a large electromagnetic vibration fixture. A large enclosure with a large sound system is unneeded. Vibrations may be focused on just a selected portion of the wood, and wood-aging can be undertaken before the instrument is assembled. The following illustrative drawings and detailed description make the foregoing and other objects, features, and advantages of the invention more apparent.

### BRIEF DESCRIPTION OF THE DRAWINGS

FIG. 1 of the drawings is a diagrammatic representation of the components used in accelerated wood-aging of a guitar according to the invention;

FIG. 2 of the drawings is a diagrammatic representation of the vibrating and sensing components adjacent a section of the wood;

### DESCRIPTION OF THE PREFERRED EMBODIMENTS

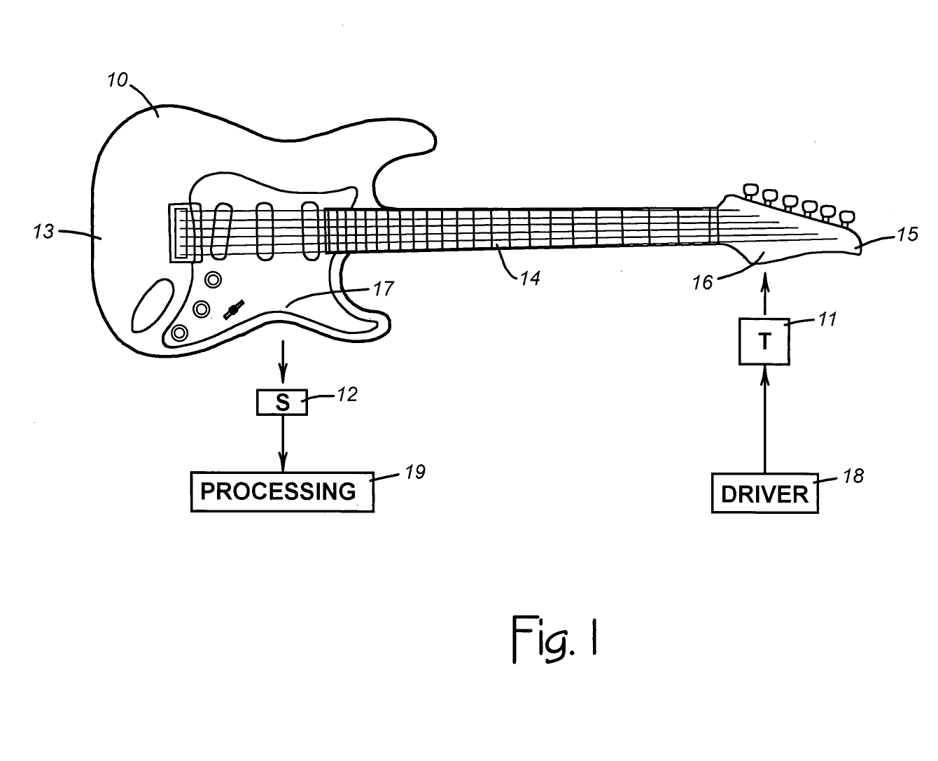

FIG. 1 of the drawings shows a guitar 10 fabricated of wood that is to be aged according to the method of the present invention using a flat-surface-supportable audio-frequency transducer device 11 while a vibration-sensing device in the form of an accelerometer device 12 senses the vibrations for frequency response analysis purposes. The wood may be aged according to the broader aspects of the invention without using the vibration-sensing accelerometer device 12, but the drawings illustrate the frequency-sensing aspect of the invention also. A block containing a letter “T” in FIG. 1 represents the transducer device 11 and a block containing a letter “S” represents the accelerometer device 12.

The guitar 10 represents a known type of wooden musical instrument that includes a wooden body portion 13, a wooden neck portion 14, and a wooden headstock portion 15. The transducer device 11 is of the type having dual symmetrically opposed motors and a broad audio frequency response characteristic (e.g., the type of component described earlier that is available under the trademark SOLIDDRIVE). The accelerometer device 12 is a known type of component for producing an electrical signal representing mechanical vibration of the device. The accelerometer device 12 may, for example, take the form of the accelerometer available as part number ACH-01-03 from Linearx Systems, Inc. of Tualatin, Oreg. The transducer device 11 couples mechanical vibrations to a user-selected first portion 16 of the wood of the guitar 10 (e.g., somewhere on the headstock portion 15) while the accelerometer 12 senses vibrations on a user-selected second portion 17 of the wood (e.g., somewhere on the body portion 13).

Electronic driver circuitry 18 (represented in block diagram form in FIG. 1) produces an electrical signal that drives the transducer device 11, thereby causing the transducer device 11 to produce vibrations at the user-selected first portion 16. The audio-frequency energy of those vibrations travels to the body portion 14 of the guitar 10 and to the user-selected second portion 17, thereby producing vibrations at the user-selected second portion 17. Those vibrations result in the accelerometer device 12 producing an electrical signal (i.e., a sensor output signal) with attributes related to the magnitude and frequency of the vibrations. That electrical signal is coupled to signal processing equipment 19 (represented in block diagram form in FIG. 1) for analysis, display, and/or recording purposes. In other words, vibrations travel to the second portion 17 and move the accelerometer device 12 accordingly, with the accelerometer device 12 responding to that movement to produce a sensor output signal related to the acceleration, velocity, and displacement (i.e., the excursion) it encounters. Of course, the wood may be aged according to the broader aspects of the invention without using the vibration-sensing accelerometer device 12.

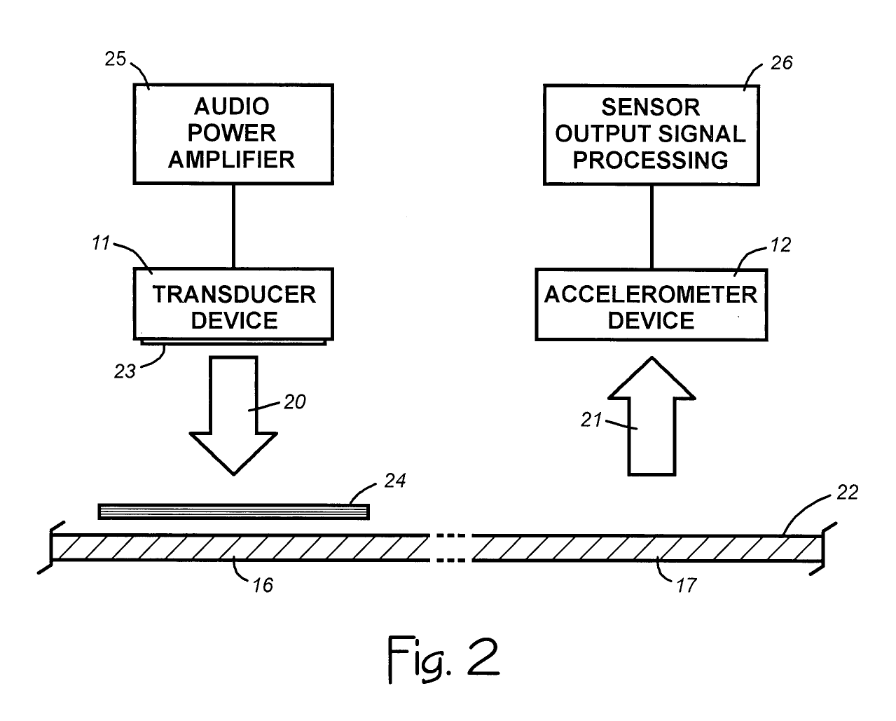

FIG. 2 is a diagrammatic representation of the various components, with two arrow outlines 20 and 21 indicating the direction of audio frequency energy flow to and from the wood 22 of the guitar 10. The transducer device 11 includes a flat surface 23 that faces the user-selected first portion 16 of the wood 22. The surface 23 (e.g., a two-inch diameter surface) may be set directly on the first portion 16 or it may, preferably, be secured to the first portion 16 temporarily with a piece of removable double-sided adhesive tape 24 (a variety of adhesive tape available from 3-M Company and other manufacturers having an adhesive substance on two oppositely facing sides) or other suitable temporary attachment/holding means. In other words, the step of placing said transducer device against the wood of the musical instrument includes providing double-sided tape and using the double-side tape to hold the transducer device on the wood of the musical instrument. Alternatively, the step of placing the transducer device against the wood of the musical instrument includes setting the transducer directly on the wood of the musical instrument. The accelerometer 12 bears against the user-selected second portion 17 of the wood 22, either directly or via the temporary attachment/holding means.

In operation, the surface 23 vibrates in response to the transducer device 11 being driven by an audio-frequency electrical signal from an audio power amplifier 25, with the audio-frequency energy of those vibrations traveling from the surface 23 to the first portion 16 of the wood 22 for wood-aging purposes. Audio-frequency power from the power amplifier 25 (part of the electronic driver circuitry 18 in FIG. 1) is set at a level in a range of about 5 watts to about 100 watts according to the aging desired and whether or not frequency sensing is being undertaken at the same time. Stated another way, the transducer device preferably has a frequency response of up to at least about 15,000 KHz and a power level capability in a range of about 5 watts to about 100 watts, and the step of driving the transducer device includes driving it with an audio signal having a frequency range of up to at least about 15,000 KHz and a power level in the range of about 5 watts to about 100 watts

When vibration sensing is undertaken, the sensor output signal from the accelerometer device 12 is coupled to sensor output signal processing equipment 26. In terms of the claim language, the method proceeds by providing means for sensing the frequency response of a selected portion of the wood, including an accelerometer device; the accelerometer device is placed against the selected portion of the wood, and the frequency response of the selected portion is sensed with the accelerometer device as the transducer device is driven by the audio signal source. The sensor output signal processing equipment 26 may include various units of commercial available equipment. A model LP201 Accelerometer Preamp available from Linearx Systems, Inc. of Tualatin, Oreg., for example, may be used with the model LMS loudspeaker measurement software available from said Linearx Systems, Inc.

Based upon the information provided herein, one of ordinary skill in the art can readily practice the invention for accelerated wood-aging purposes and/or wood frequency response analysis, display, and/or mapping and recording. One aging technique involves aging the wood of the musical instrument and mapping the frequency response of the wood until the wood has a frequency response similar to the frequency response of some other musical instrument of interest. In other words, the methodology may be used to replicate instruments of known high quality.

Recapping the mapping methodology employed for mapping the frequency response of the wood of a musical instrument, the method proceeds by (i) providing a flat-surface-supportable audio-frequency transducer device of the type having dual symmetrically opposed motors and a broad audio frequency response characteristic, (ii) providing means for driving said transducer device, including an audio signal source, and (iii) providing means for sensing the frequency response of a first selected portion of the wood, including an accelerometer device. The mapping method proceeds by placing the transducer device against the wood of the musical instrument, placing the accelerometer device against the first selected portion of the wood, driving said transducer device with the audio signal source in order to thereby subject the wood to audio vibrations, sensing the frequency response of the first selected portion of the wood with the accelerometer device as said transducer device is driven by the audio signal source, saving information representing the location on the wood of the first selected portion of the wood and the frequency response of the first selected portion of the wood, and repeating the foregoing steps for other selected portions of the wood instead of the first selected portion of the wood in order to produce a map of the frequency response of the wood.

Using the methodology of the present invention, one can, for example, measure the response of the body or neck of a guitar prior to and after applying paint, attaching hardware, and chambering the body to see the affect of those additions. The response of different types and weights of wood can be measured also. Those measurements are compared to measurements made after the neck is attached to the body to determine the interrelationship of the components and the effect of various attachment methods on the vibration of the guitar. In addition, one can vibrate the body of the guitar while monitoring the response of the guitar amplifier for purposes of determining whether the guitar pickups/electronics are faithfully reproducing the vibrations created by the woods. Pickups/electronics are adjusted to focus on the frequency response desired.

Thus, the invention uses a special form of transducer device for the flexibility it provides in vibrating the wood for accelerated aging. In one form of the invention, it uses existing loudspeaker measurement hardware and software to analyze the frequency response of the wood. The user is not power limited or limited by complicated string-threatening hardware as to just where on the guitar a vibrations-transferring screw can be located. There are not the time, expense, space requirements, and potential for damage of securing the instrument to a large electromagnetic vibration fixture. A large enclosure with a large sound system is unneeded. Vibrations may be focused on just a selected portion of the wood, and wood-aging can be undertaken before the instrument is assembled.

Although an exemplary embodiment has been shown and described, one of ordinary skill in the art may make many changes, modifications, and substitutions without necessarily departing from the spirit and scope of the invention. As for the specific terminology used to describe the exemplary embodiment, it is not intended to limit the invention; each specific term is intended to include all technical equivalents that operate in a similar manner to accomplish a similar purpose or function.

What is claimed is:

1. A method for aging the wood of a musical instrument, comprising:
providing a flat-surface-supportable audio-frequency transducer device of the type having dual symmetrically opposed motors and a broad audio frequency response characteristic;
providing means for driving said transducer device, including an audio signal source;
placing said transducer device against the wood of the musical instrument; and
driving said transducer device with the audio signal source in order to thereby subject the wood to audio vibrations for accelerated wood-aging purposes.

2. A method as recited in claim 1, wherein the step of placing said transducer device against the wood of the musical instrument includes providing double-sided tape and using the double-side tape to hold the transducer device on the wood of the musical instrument.

3. A method as recited in claim 1, wherein the step of placing said transducer device against the wood of the musical instrument includes setting the transducer directly on the wood of the musical instrument.

4. A method as recited in claim 1, wherein musical instrument has a body portion and the step of placing said transducer device against the wood of the musical instrument includes placing said transducer against the body portion.

5. A method as recited in claim 1, wherein the musical instrument has a neck portion and the step of placing said transducer device against the wood of the musical instrument includes placing said transducer against the neck portion.

6. A method as recited in claim 1, wherein the musical instrument has a headstock portion and the step of placing said transducer device against the wood of the musical instrument includes placing said transducer against the headstock portion.

7. A method as recited in claim 1, wherein:
said transducer device has a frequency response of up to at least about 15,000 KHz and a power level capability in a range of about 5 watts to about 100 watts; and
the step of driving said transducer device includes driving said transducer device with an audio signal having a frequency range of up to at least about 15,000 KHz and a power level in the range of about 5 watts to about 100 watts.

8. A method as recited in claim 1, further comprising:
providing means for sensing the frequency response of a selected portion of the wood, including an accelerometer device;
placing the accelerometer device against the selected portion of the wood; and
sensing the frequency response of the selected portion of the wood with the accelerometer device as said transducer device is driven by the audio signal source.

9. A method as recited in claim 8, further comprising mapping the frequency response of the wood.

10. A method as recited in claim 8, further comprising aging the wood of the musical instrument and mapping the frequency response of the wood until the wood has a frequency response similar to the frequency response of some other musical instrument of interest.

11. A method for mapping the frequency response of the wood of a musical instrument, comprising:
providing a flat-surface-supportable audio-frequency transducer device of the type having dual symmetrically opposed motors and a broad audio frequency response characteristic;
providing means for driving said transducer device, including an audio signal source;
providing means for sensing the frequency response of a first selected portion of the wood, including an accelerometer device;
placing said transducer device against the wood of the musical instrument;
placing the accelerometer device against the first selected portion of the wood;
driving said transducer device with the audio signal source in order to thereby subject the wood to audio vibrations;
sensing the frequency response of the first selected portion of the wood with the accelerometer device as said transducer device is driven by the audio signal source;
saving information representing the location on the wood of the first selected portion of the wood and the frequency response of the first selected portion of the wood; and
repeating the foregoing steps for other selected portions of the wood instead of the first selected portion of the wood in order to produce a map of the frequency response of the wood.
